(19) United States
(12) Patent Application Publication
(10) Pub. No.: US 2026/0023685 A1
(43) Pub. Date: Jan. 22, 2026

(54) APPARATUS AND METHOD FOR PHASED VALID LPN BITMAP GENERATION

(71) Applicant: Samsung Electronics Co., Ltd., Suwon-si (KR)

(72) Inventors: Rakesh BALAKRISHNAN, Bengaluru (IN); Manoj Kumar TANGELLA, Bengaluru (IN)

(73) Assignee: Samsung Electronics Co., Ltd., Suwon-si (KR)

(21) Appl. No.: 19/263,701

(22) Filed: Jul. 9, 2025

(30) Foreign Application Priority Data
Jul. 18, 2024 (IN) 202441054829
May 30, 2025 (IN) 202441054829

(51) Int. Cl. G06F 12/02

(52) U.S. Cl. CPC G06F 12/0253; G06F 12/0246

(57) ABSTRACT

A method for generating valid Logical Page Number (LPN) bitmap for a storage device may include dividing a Super Block (SB) into a plurality of sections, generating at least one SB Logical-to-Physical (L2P) bitmap (SBL2P bitmap) for at least one section of the plurality of sections of the SB, in response to a write request from a host device associated with the at least one section of the SB, each set bit of the SBL2P bitmap indicating that valid data is stored in at least one LPN in the at least one section of the SB, and generating a valid LPN bitmap corresponding to the SB in response to a Garbage Collection (GC) operation based on the generated at least one SBL2P bitmap, each bit of the valid LPN Bitmap representing validity information of data stored in a corresponding physical location of the SB.

### CROSS-REFERENCE TO RELATED APPLICATION

This U.S. non-provisional application claims the benefit of priority under 35 U.S.C. § 119 to Indian Non-Provisional patent application No. 202441054829, filed on Jul. 18, 2024, and Indian Non-Provisional patent application No. 202441054829, filed on May 30, 2025, in the Indian Intellectual Property Office, the disclosures of each which are incorporated by reference herein in their entirety.

### BACKGROUND

Some example embodiments of the inventive concepts relate to the field of Solid-State Drives (SSDs). Particularly, but not exclusively, one or more of the example embodiments of the inventive concepts relate to generation of valid Logical Page Number (LPN) bitmap in a phased manner for a super block in an SSD.

Solid-State Drives (SSDs) without Dynamic Random-Access Memory (DRAM) (e.g., DRAMLess storage products) must meet stringent sustained write performance requirements. This is particularly challenging for Quad-Level Cell (QLC) SSDs, which have higher data density and typically lower performance characteristics. Meeting the sustained write performance for random data across the full range of the storage device, especially in scenarios with Normal Power Off (NPO), is highly demanding.

Due to the lack of DRAM in DRAMLess SSDs, identifying which Logical Page Number (LPN) is valid in a Super Block (SB) during a Garbage Collection (GC) operation takes a lot of time. Only valid LPNs need to be garbage collected to avoid an increase in the Write Amplification Factor (WAF) and to reduce GC time. In existing technologies, identifying valid LPNs comprises loading the data from a NAND flash memory, finding the LPN from spare data of the page, and then loading corresponding meta page (L2P) to check if the LPN belongs to the source block where the GC operation is in progress. When the data in the source block is random in nature, the same meta page needs to be loaded multiple times, which is an inefficient process. In some cases, it is also possible that after loading the data of a page, it is determined that there is no valid data in that page at all. Thus, the loading of that page did not result in useful garbage collection and needs to be reduced and/or avoided.

Also, in SSDs without DRAM, there is an inability to cache the entire metadata (e.g., the L2P Table) of the whole drive capacity in DRAM. Consequently, there are multiple meta reads and/or meta writes, and because the Static Random-Access Memory (SRAM) is limited in memory, a lot of GC data cannot be stored in the SRAM. Hence, without DRAM, caching large amounts of data in the SRAM for the GC process across all banks in the storage device becomes unfeasible. Therefore, to cache valid data in the SRAM in an improved and/or more efficient manner, having a valid LPN bitmap is desired and/or essential. Additionally, many SSDs do not support program suspend, causing potential delays in GC reads and/or metadata reads due to ongoing GC programs, resulting in bank-to-bank collision of the meta loads, GC reads, and/or the GC program further causing an impact in the sustained write performance of the SSDs. To reduce and/or prevent these bank-to-bank collisions, knowing the valid LPNs in a page beforehand facilitates the improved and/or optimal scheduling of GC operations. However, generating the SB LPN bitmap for the entire SB is time-consuming, potentially leading to host (e.g., host computer, host device, etc.) command timeouts.

The information disclosed in this background of the disclosure section is only for enhancement of understanding of the general background of the inventive concepts and should not be taken as an acknowledgement or any form of suggestion that this information forms the prior art already known to a person of ordinary skill in the art.

### SUMMARY

One or more example embodiments of the inventive concepts are described in detail herein.

In at least one example embodiment, a method of generating valid Logical Page Number (LPN) bitmaps for a storage device including a plurality of super blocks of non-volatile memory and a storage controller is disclosed. The method comprises dividing a Super Block (SB) into a plurality of sections based on a size of the SB and a size of a volatile memory included in the storage controller, for a write operation to be performed by the storage device, generating at least one SB Logical-to-Physical (L2P) bitmap (SBL2P bitmap) for at least one section of the plurality of sections of the SB, in response to a write request from a host device associated with the at least one section of the SB, each set bit of the SBL2P bitmap indicating that valid data is stored in at least one LPN in the at least one section of the SB, and generating a valid LPN bitmap corresponding to the SB in response to a Garbage Collection (GC) operation based on the generated at least one SBL2P bitmap, each bit of the valid LPN Bitmap representing validity information of data stored in a corresponding physical location of the SB.

In at least one example embodiment, the generating the SBL2P bitmap for the at least one section of the SB further includes setting one or more bits in the SBL2P bitmap corresponding to L2P table indices of the LPNs written to the storage device by the host device.

In at least one example embodiment, the method further comprises storing the generated SB L2P bitmap in a non-volatile memory of the storage device.

In at least one example embodiment, the generating the valid LPN bitmap corresponding to the SB further includes loading the SBL2P bitmap corresponding to the section of the SB for which the GC operation is to be performed, determining one or more valid LPNs based on the loaded SBL2P bitmap, the determining including loading L2P pages corresponding to each set bit of the loaded SBL2P bitmap and parsing the loaded L2P pages, generating a part of the valid LPN bitmap corresponding to the section of the SB based on the one or more valid LPNs, and in response to completion of the GC operation using the generated part of the valid LPN bitmap, loading a SBL2P bitmap of a subsequent section of the SB to generate a subsequent part of the valid LPN bitmap.

In at least one example embodiment, a single part of the valid LPN bitmap is generated at a time.

In at least one example embodiment, the method further comprises storing the generated valid LPN bitmap in a non-volatile memory of the storage device during a Normal Power Off (NPO) operation to avoid re-generation of the valid LPN bitmap after a wake up operation is performed by the host device.

In at least one example embodiment, an apparatus to generate valid Logical Page Number (LPN) bitmaps for a storage device is disclosed. The apparatus comprises a storage controller including a volatile memory; and a non-volatile memory including a plurality of Super Blocks (SBs), each SB including a plurality of physical blocks, wherein the storage controller configured to divide a Super Block (SB) into a plurality of sections based on a size of the SB and a size of the volatile memory included in a storage controller, for a write operation to be performed by the storage device, generate at least one SB Logical-to-Physical (L2P) bitmap (SBL2P bitmap) for at least one section of the plurality of sections of the SB, in response to a write request from a host device associated with the at least one section of the SB, each set bit of the SBL2P bitmap indicating that valid data is stored in at least one LPN in the at least one section of the SB, and generate a valid LPN bitmap corresponding to the SB in response to a Garbage Collection (GC) operation based on the generated at least one SBL2P bitmap, each bit of the valid LPN Bitmap representing validity information of data stored in a corresponding physical location of the SB.

In at least one example embodiment, the storage controller is further configured to generate the SBL2P bitmap for each section of the SB by setting one or more bits in the SBL2P bitmap corresponding to L2P table indices of the LPNs written to the storage device by the host device.

In at least one example embodiment, the storage controller is further configured to store the generated SB L2P bitmap in a non-volatile memory of the storage device.

In at least one example embodiment, the storage controller is configured to generate the valid LPN bitmap corresponding to the SB by loading into the volatile memory the SBL2P bitmap corresponding to the section of the SB for which the GC operation is to be performed, determining one or more valid LPNs based on the loaded SBL2P bitmap, the determining including loading L2P pages corresponding to each set bit of the loaded SBL2P bitmap and parsing the loaded L2P pages, generating a part of the valid LPN bitmap corresponding to the section of the SB based on the one or more valid LPNs, and in response to completion of the GC operation using the generated part of the valid LPN bitmap, loading into the volatile memory a SBL2P bitmap of a subsequent section of the SB to generate a subsequent part of the valid LPN bitmap.

In at least one example embodiment, a single part of the valid LPN bitmap is generated at a time.

In at least one example embodiment, the storage controller is further configured to store the generated valid LPN bitmap in a non-volatile memory of the storage device during a Normal Power Off (NPO) operation to avoid re-generation of the valid LPN bitmap after a wake up operation of the host device.

In at least one example embodiment, a system may comprise, at least one host device, and a storage device including a non-volatile memory and a storage controller including a volatile memory, the storage controller configured to, divide a Super Block (SB) of the non-volatile memory into a plurality of sections based on a size of the volatile memory, generate a plurality of SB Logical-to-Physical (L2P) bitmaps (SBL2P bitmap), each SL2P bitmap corresponding to one section of the plurality of sections of the SB, receive a write request from the at least one host device, the write request indicating a target section of the plurality of sections of the SB, in response to the write request, set a bit of the SBL2P bitmap in a position of the SBL2P bitmap corresponding to the target section, the set bit indicating that valid data is stored in a Logical Page Number (LPN) corresponding to the target section, and generate a valid LPN bitmap corresponding to the SB in response to an instruction to perform a Garbage Collection (GC) operation on the storage device based on the generated SBL2P bitmap, each bit of the valid LPN bitmap representing validity information of data stored in a corresponding physical location of the SB.

In at least one example embodiment, the storage controller is further configured to store the generated SB L2P bitmap in the non-volatile memory.

In at least one example embodiment, the storage controller is further configured to in response to receiving a request to change data stored in the target section of the plurality of sections of the SB, clearing the set bit of the SBL2P bitmap in the position of the SBL2P bitmap corresponding to the target section.

In at least one example embodiment, the storage controller is further configured to in response to receiving a request to delete data stored in the target section of the plurality of sections of the SB, clearing the set bit of the SBL2P bitmap in the position of the SBL2P bitmap corresponding to the target section.

In at least one example embodiment, the storage controller is further configured to receive a request to perform the GC operation on the SB from the at least one host device, load a first SBL2P bitmap corresponding to a first section of the SB for which the GC operation is to be performed into the volatile memory from the non-volatile memory, determine one or more valid LPNs based on the loaded first SBL2P bitmap, the determining including loading L2P pages corresponding to each set bit of the loaded first SBL2P bitmap into the volatile memory, generate a first part of the valid LPN bitmap corresponding to the first section of the SB based on the one or more valid LPNs, and in response to completion of the GC operation using the generated part of the valid LPN bitmap, load a second SBL2P bitmap corresponding to a second section of the SB to generate a second part of the valid LPN bitmap.

In at least one example embodiment, the storage controller is further configured to load a single part of the valid LPN bitmap into the volatile memory at a time.

In at least one example embodiment, the storage controller is further configured to store the generated valid LPN bitmap in the non-volatile memory during a Normal Power Off (NPO) operation of the host device.

In at least one example embodiment, the storage controller is further configured to load the valid LPN bitmap into the volatile memory from the non-volatile memory after a wake up operation is performed by the host device.

The foregoing summary is illustrative only and is not intended to be in any way limiting. In addition to the illustrative aspects, example embodiments, and features described above, further aspects, example embodiments, and features will become apparent by reference to the drawings and the following detailed description.

### BRIEF DESCRIPTION OF THE DRAWINGS

To easily identify the discussion of any particular element or act, the most significant digit(s) in a reference number refer(s) to the figure number in which that element is first introduced.

FIG. 1 illustrates a Super Block (SB) Logical-to-Physical (L2P) bitmap generation in accordance with the related art.

FIG. 2 illustrates valid Logical Page Number (LPN) bitmap generation in accordance with at least one example embodiment of the inventive concepts.

FIG. 3 illustrates an SB L2P bitmap generation in accordance with at least one example embodiment of the inventive concepts.

FIG. 4 illustrates phased valid LPN bitmap generation in accordance with at least one example embodiment of the inventive concepts.

FIG. 5 illustrates a Solid-State Drive (SSD) in accordance with at least one example embodiment of the inventive concepts.

FIG. 6 illustrates a flow diagram of a method for generating valid LPN bitmap in accordance with at least one example embodiment of the inventive concepts.

It should be appreciated by a person of ordinary skill in the art that any block diagrams herein represent conceptual views of one or more example embodiments of the inventive concepts. Similarly, it will be appreciated that any flowcharts, flow diagrams, state transition diagrams, pseudo code, and the like, represent various processes which may be substantially represented in non-transitory computer readable media and may executed by a computer or processor, whether or not such computer or processor is explicitly shown.

### DETAILED DESCRIPTION

For the purpose of promoting an understanding of one or more example embodiments of the inventive concepts, reference will now be made. It will nevertheless be understood that alterations and further modifications in the example embodiments may be made, and such further applications of the principles of the inventive concepts are contemplated.

It will be understood by a person of ordinary skill in the art that the foregoing general description and the following detailed description are explanatory of the inventive concepts and are not intended to be restrictive thereof.

In the present document, the word “exemplary” is used herein to mean “serving as an example, instance, or illustration.” Any example embodiment or implementation of the inventive concepts described herein as “exemplary” is not necessarily to be construed as preferred or advantageous over other example embodiments.

While the example embodiments are susceptible to various modifications and alternative forms, some example embodiments have been shown by way of example in the drawings and will be described in detail below. It should be understood, however, that it is not intended to limit the example embodiments to the particular forms disclosed, but on the contrary, the disclosure is to cover all modifications, equivalents, and alternative falling within the spirit and the scope of the inventive concepts.

The terms “comprise”, “comprising”, or any other variations thereof, are intended to cover a non-exclusive inclusion, such that a system, device, and/or method that comprises a list of components and/or operations does not include only those components and/or operations, but may include other components and/or operations not expressly listed or inherent to such setup or device or method. In other words, one or more elements in a device and/or system proceeded by “comprises . . . a” does not, without more constraints, preclude the existence of other elements and/or additional elements in the device and/or system.

The terms like “at least one” and “one or more” may be used interchangeably throughout the description. In the following detailed description of some example embodiments of the inventive concepts, reference is made to the accompanying drawings that form a part hereof, and in which are shown by way of illustration some example embodiments in which the inventive concepts may be practiced. These example embodiments are described in sufficient detail to enable those of ordinary skill in art to practice the inventive concepts, and it is to be understood that other example embodiments may be utilized and that changes may be made without departing from the scope of the inventive concepts. The following description is, therefore, not to be taken in a limiting sense. In the following description, well known functions or constructions are not described in detail since they would obscure the description with unnecessary detail.

A Solid-State Drive (SSD) comprises a plurality of physical blocks (e.g., memory blocks) and a group of a plurality of physical blocks is known as a Super Block (SB). Each block in the SSD comprises a plurality of pages. A page is the smallest unit of size of an SSD to which data can be written by a host device. Every page in the SSD is associated with a page number known as a Logical Page Number (LPN). The LPN of a page is said to be valid if the page contains and/or stores the original data written to it. Whenever the data written on a page is deleted, the LPN of that page becomes invalid. Also, if the data written to a page is altered and/or modified, the new data is written to a new physical page. The previous Physical Page Number (PPN) is marked as invalid and the mapping of the LPN is updated to the new PPN. To perform a Garbage Collection (GC) operation for the SSD, only valid LPNs are desired and/or required.

One or more example embodiments of the inventive concepts relate to the generation of valid LPN bitmap in a phased manner for a Dynamic Random Access Memory Less (DRAMLess) SSD during the GC operation, but the example embodiments are not limited thereto. The valid LPN bitmap is generated by dividing a SB of the SSD into a plurality of sections and generating a plurality of parts (e.g., subsets and/or portions, etc.) of the valid LPN bitmap corresponding to the plurality of sections of the SB.

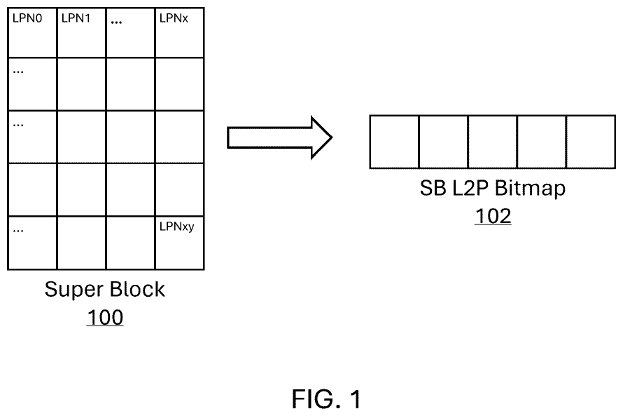

FIG. 1 illustrates a Super Block (SB) Logical-to-Physical (L2P) bitmap 102 generation in accordance with the related art. An SB L2P bitmap in an SSD is a bit-level map used to track the L2P pages corresponding to the LPNs present in the SB. The SB L2P bitmap is used to understand more about the state of blocks or pages in the SSD's memory. In the SB L2P bitmap, a bit is set when at least one LPN referred to by the corresponding L2P page is present in the SB. For example, if bit 10 is set, then any one of the LPNs addressed by L2P Page 10 is present in the SB.

An SB 100 may contain a plurality of pages to which data may be written by a host device. Each page among the plurality of pages may have a Logical Page Number (LPN) LPN0, LPN1, LPN2, . . . , LPNxy. The SB L2P bitmap 102 may be generated for all of the pages contained in the SB 100. The SB L2P bitmap 102 may contain information for all of the pages contained in the SB 100. The SB L2P bitmap 102 may occupy a large amount of memory since a single bitmap is generated for all of the pages of the SB 100.

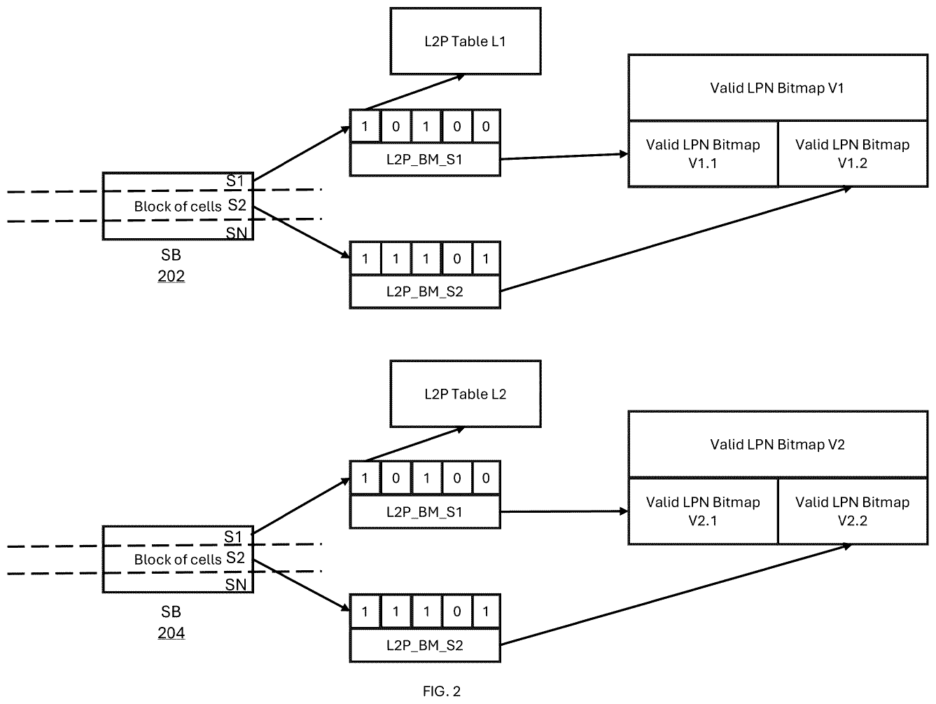

FIG. 2 illustrates valid LPN bitmap generation in accordance with at least one example embodiment of the inventive concepts. An SB 202 may be divided into a plurality of sections, e.g., S1, S2, . . . , SN. A plurality of SB L2P bitmaps may be generated corresponding to the plurality of sections S1, S2, . . . , SN of the SB 202. For example, an SB L2P bitmap L2P_BM_S1 may be generated for the section S1 of the SB 202, an SB L2P bitmap L2P_BM_S2 may be generated for the section S2 of the SB 202, an SB L2P bitmap L2P_BM_SN (not shown) may be generated for the section SN of the SB 202, etc., but the example embodiments are not limited thereto. The plurality of SB L2P bitmaps L2P_BM_S1, L2P_BM_S2, . . . , L2P_BM_SN may be generated as a plurality of chunks of an SB L2P bitmap corresponding to the whole SB 202, but are not limited thereto.

A plurality of parts (e.g., subsets, portions, etc.) of the valid LPN bitmap may be generated in a phased manner (e.g., sequential, distributed, delayed, etc.) corresponding to the plurality of sections S1, S2, . . . , SN of the SB 202. The plurality of parts of the valid LPN bitmap may be generated based on the information comprised in the plurality of SB L2P bitmaps. A first part V1.1 of the valid LPN bitmap may be generated corresponding to the section S1 of the SB 202 based on the information comprised in the SB L2P bitmap L2P_BM_S1. A second part V1.2 of the valid LPN bitmap may be generated corresponding to the section S2 of the SB 202 based on the information comprised in the SB L2P bitmap L2P_BM_S2. An N^{th} part V1.N (not shown) of the valid LPN bitmap may be generated corresponding to the section SN of the SB 202 based on the information comprised in the SB L2P bitmap L2P_BM_SN. The plurality of parts V1.1, V1.2, . . . , V1.N of the valid LPN bitmap may be generated as a plurality of chunks of a valid LPN bitmap V1 corresponding to the whole SB 202, etc.

Similarly, an SB 204 may be divided into a plurality of sections S1, S2, . . . , SN, but is not limited thereto. A plurality of SB L2P bitmaps may be generated corresponding to the plurality of sections S1, S2, . . . , SN of the SB 204. For example, an SB L2P bitmap L2P_BM_S1 may be generated for the section S1 of the SB 204, an SB L2P bitmap L2P_BM_S2 may be generated for the section S2 of the SB 204, and/or an SB L2P bitmap L2P_BM_SN (not shown) may be generated for the section SN of the SB 204, but the example embodiments are not limited thereto. The plurality of SB L2P bitmaps L2P_BM_S1, L2P_BM_S2, . . . , L2P_BM_SN may be generated as a plurality of chunks (e.g., subsets, portions, etc.) of an SB L2P bitmap corresponding to the whole SB 204.

A plurality of parts of the valid LPN bitmap may be generated in a phased manner corresponding to the plurality of sections S1, S2, . . . , SN of the SB 204. The plurality of parts of the valid LPN bitmap may be generated based on the information comprised and/or included in the plurality of SB L2P bitmaps. A first part V2.1 of the valid LPN bitmap may be generated corresponding to the section S1 of the SB 204 based on the information comprised in the SB L2P bitmap L2P_BM_S1. A second part V2.2 of the valid LPN bitmap may be generated corresponding to the section S2 of the SB 204 based on the information comprised in the SB L2P bitmap L2P_BM_S2. An N^{th} part V2.N (not shown) of the valid LPN bitmap may be generated corresponding to the section SN of the SB 204 based on the information comprised in the SB L2P bitmap L2P_BM_SN. The plurality of parts V2.1, V2.2, . . . , V2.N of the valid LPN bitmap may be generated as a plurality of chunks of a valid LPN bitmap V2 corresponding to the whole SB 204.

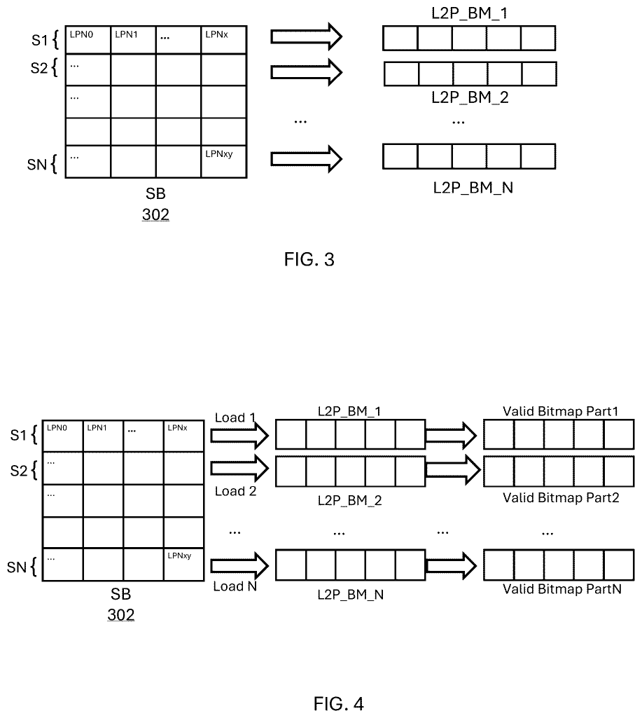

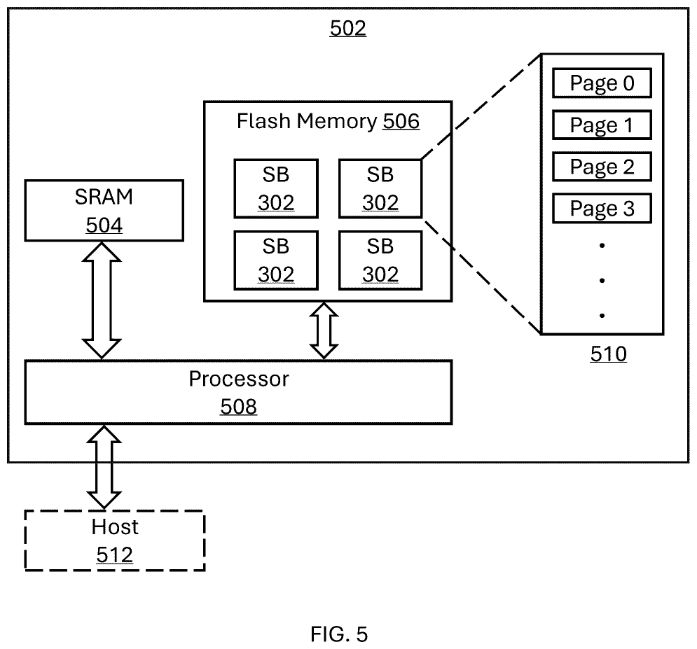

FIG. 3 illustrates an SB L2P bitmap generation in accordance with at least one example embodiment of the inventive concepts. An SB 302 may contain a plurality of pages corresponding to a plurality of LPNs. A host device may write data to the SB 302 of a storage device (e.g., the SSD 502 of FIG. 5, etc.). In at least one example embodiment, the host device may provide one or more instructions to at least one processor (e.g., processing circuitry, storage controller, etc.) included in the storage device (e.g., the SSD) to write the data to the SB 302. At the time of host write, the SB 302 may be divided into a plurality of sections S1, S2, . . . , SN based on a size of the SB and a size of a volatile memory, for example, Static Random Access Memory (SRAM) for write operation to be performed by a host device without impacting the Write Amplification Factor (WAF). A plurality of SB L2P bitmaps may be generated corresponding to the plurality of sections S1, S2, . . . , SN of the SB 302. According to some example embodiments, the at least one processor may be implemented as a storage controller. The storage controller may include hardware or hardware circuit including logic circuits; a hardware/software combination such as a processor executing software and/or firmware; or a combination thereof. For example, the storage controller more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

In at least one example embodiment, the plurality of pages may be divided equally among the plurality of sections S1, S2, . . . , SN of the SB 302, but is not limited thereto. In at least one other example embodiment, the plurality of pages may be divided unequally among the plurality of sections S1, S2, . . . , SN of the SB 302. When the data is written to each section among the plurality of sections S1, S2, . . . , SN of the SB 302, the data may be written to the plurality of pages comprised in and/or included in the corresponding section of the SB 302.

An SB L2P bitmap L2P_BM_1 may be generated corresponding to the section S1 of the SB 302. The SB L2P bitmap L2P_BM_1 may contain a plurality of L2P pages corresponding to the plurality of LPNs corresponding to the plurality of pages of the section S1 of the SB 302. As the data is written to the section S1 of the SB 302 and/or in response to the instruction to write data to the section S1 of the SB 302, etc., a bit may be set for an L2P page corresponding to the LPN in the SB L2P bitmap L2P_BM_1, the LPN and L2P page corresponding to a page to which the data is written (and/or the page where the data is to be written). A bit may be cleared for an L2P page corresponding to an LPN in the SB L2P bitmap L2P_BM_1, the LPN and L2P page corresponding to a page to which the data is not written. For example, if the data stored on the target page is changed, modified, and/or deleted, the bit for L2P page corresponding to the LPN corresponding to that page is cleared in the SB L2P bitmap L2P_BM_1, etc. In other words, in response to a request to change the data and/or delete the data stored in the target page, the bit for the L2P page corresponding to the LPN is cleared in the corresponding SB L2P bitmap. Once the data writing operation is completed for the section S1 of the SB 302, the SB L2P bitmap L2P_BM_1 may be stored in a flash memory and/or other non-volatile memory of the storage device.

Further, an SB L2P bitmap L2P_BM_2 may be generated corresponding to the section S2 of the SB 302. The SB L2P bitmap L2P_BM_2 may contain a plurality of L2P pages corresponding to a plurality of LPNs corresponding to the plurality of pages of the section S2 of the SB 302. As the data is written to the section S2 of the SB 302 and/or in response to an instruction to write data to the section S2 of the SB 302, etc., a bit may be set for an L2P page corresponding to an LPN in the SB L2P bitmap L2P_BM_2, the LPN (and L2P page) corresponding to a page to which the data is written. A bit may be cleared for an L2P page corresponding to an LPN in the SB L2P bitmap L2P_BM_2, the LPN (and L2P page) corresponding to a page to which data is not written. For example, if the data written to and/or stored on a page is changed and/or deleted, the bit for the L2P page corresponding to the LPN corresponding to that page may be cleared in the SB L2P bitmap L2P_BM_2. Once the data writing operation is completed for the section S2 of the SB 302, the L2P_BM_2 may be stored in the flash memory (e.g., non-volatile memory), but is not limited thereto.

Similarly, an SB L2P bitmap L2P_BM_N may be generated corresponding to the section SN of the SB 302. The SB L2P bitmap L2P_BM_N may contain a plurality of L2P pages corresponding to a plurality of LPNs corresponding to the plurality of pages of the section SN of the SB 302. As the data is written to the section SN of the SB 302 and/or in response to the instruction to write data to the section SN of the SB 302, etc., a bit may be set for an L2P pages corresponding to an LPN in the SB L2P bitmap L2P_BM_N corresponding to a page to which the data is written. A bit may be cleared for an L2P pages corresponding to an LPN, in the SB L2P bitmap L2P_BM_N corresponding to a page to which data is not written. If the data written to (e.g., stored on) a page is changed and/or deleted, the bit for the L2P pages corresponding to the LPN corresponding to that page may be cleared in the SB L2P bitmap L2P_BM_N. Once the data writing operation is completed for the section SN of the SB 302, the SB L2P bitmap L2P_BM_N may be stored in the flash memory (e.g., non-volatile memory, NAND memory, etc.), but is not limited thereto.

FIG. 4 illustrates phased valid LPN bitmap generation in accordance with at least one example embodiment of the inventive concepts. The valid LPN bitmap for the SB 302 may be generated by generating a plurality of parts (e.g., subsets and/or portions, etc.) of the valid LPN bitmap in a phased manner corresponding to the plurality of sections of the SB 302. At the time of the valid LPN bitmap generation, if a bit for an L2P page corresponding to an LPN, corresponding to a memory page, in an SB L2P bitmap is set, it may mean that the page contains the data written to it (e.g., the page stores valid data) and the LPN is a valid LPN.

In the first phase, the SB L2P bitmap L2P_BM_1 corresponding to the section S1 of the SB 302 may be loaded into SRAM of an SSD, but the example embodiments are not limited thereto, and for example, other types of volatile memory may be used. The SB L2P bitmap L2P_BM_1 may be analyzed to determine one or more valid LPNs corresponding to each bit of the loaded SBL2P bitmap L2P_BM_1 of the section S1 that contains the data written by the host device during the generation of the SB L2P bitmap L2P_BM_1 (e.g., the LPNs store valid data, unmodified data, etc.). Since each bit of SBL2PBitmap represents a L2P page, for each bit set in SBL2PBitmap, the corresponding L2P Page is loaded from NAND memory (e.g., non-volatile memory) to SRAM (e.g., volatile memory), but the example embodiments are not limited thereto. The loaded L2P pages may be parsed and/or analyzed to check if any of the L2P entries are mapped to the section S1 of the SB 302. If any of the L2P entries are mapped to the section S1 of the SB 302, they are considered valid LPNs and a corresponding bit is set in the first part of the valid LPN bitmap. A first part Part1 of the valid LPN bitmap includes information about the one or more valid LPNs in the section S1 and may be generated. One or more GC read commands may be executed for the one or more pages corresponding to the one or more valid LPNs included in the Part1 of the valid LPN bitmap and the GC operation may be performed for the section S1 of the SB 302, etc.

After completion of the GC operation for the section S1 of the SB 302, in the second phase, the SB L2P bitmap L2P_BM_2 corresponding to section S2 (e.g., a next section, a subsequent section, etc.) of the SB 302 may be loaded into the SRAM (e.g., volatile memory) of the SSD (e.g., the storage device), etc. The SB L2P bitmap L2P_BM_2 may be analyzed to determine one or more valid LPNs by loading L2P page corresponding to each bit of the loaded SBL2P bitmap L2P_BM_2 of the section S2 that contains the data written by the host device during the generation of the SB L2P bitmap L2P_BM_2, etc. Since each bit of SBL2PBitmap represents a L2P page, for each bit set in SBL2PBitmap, the corresponding L2P Page is loaded from NAND memory (e.g., nonvolatile memory) to SRAM (e.g., volatile memory), but the example embodiments are not limited thereto. A second part Part2 of the valid LPN bitmap including information about the one or more valid LPNs in the section S2 may be generated in this fashion. One or more GC read commands may be executed for the one or more pages corresponding to the one or more valid LPNs included in the Part2 of the valid LPN bitmap and the GC operation may be performed for the section S2 of the SB 302, etc.

Similarly, in the N^{th} phase, the SB L2P bitmap L2P_BM_N corresponding to the section SN of the SB 302 may be loaded into the SRAM (e.g., the volatile memory) of the SSD (e.g., storage device), but the example embodiments are not limited thereto. The SB L2P bitmap L2P_BM_N may be analyzed to determine one or more valid LPNs corresponding to one or more pages of the section SN that contains the data written by the host device during the generation of the SB L2P bitmap L2P_BM_N. Since each bit of SBL2PBitmap represents a L2P page, for each bit set in SBL2PBitmap, the corresponding L2P Page is loaded from NAND (e.g., nonvolatile memory) memory to SRAM (e.g., volatile memory), etc. An N^{th} PartN of the valid LPN bitmap including information about the one or more valid LPNs in the section SN may be generated in this fashion. One or more GC read commands may be executed for the one or more pages corresponding to the one or more valid LPNs included in the PartN of the valid LPN bitmap and the GC operation may be performed for the section SN of the SB 302, but the example embodiments are not limited thereto.

FIG. 5 illustrates a Solid State Drive (SSD) 502 in accordance with at least one example embodiment of the inventive concepts. The SSD 502 (e.g., the storage device) may be a DRAMLess SSD, but is not limited thereto. The SSD 502 may include an SRAM 504 (e.g., volatile memory), a flash memory 506 (e.g., nonvolatile memory), and/or at least one processor 508 (e.g., processing circuitry, etc.), but not limited thereto. A volatile memory and a storage controller, for example the processing circuitry including at least one processor 508 may be implemented in a storage controller in the SSD. So, basically, the size of the volatile memory in the storage controller may be much smaller in size compared to a size of DRAM memory in the SDD due to a manufacturing cost. In at least one example embodiment, the SSD 502 may include one or more processors 508. In at least one example embodiment, the one or more processors 508 may be present outside (e.g., external to) the SSD 502, but the example embodiments are not limited thereto. In at least one example embodiment, the flash memory 506 may be a non-volatile NAND flash memory and may include a plurality of SBs, but is not limited thereto. Each SB 302 among the plurality of SBs may include a plurality of pages 510. The flash memory 506 may store one or more instructions for the operation of one or more functions of the SSD 502. The processor 508 may execute the one or more instructions stored in the flash memory 506 to perform the one or more functions of the SSD 502. The processor 508 may be communicatively coupled with a host device 512. In at least one example embodiment, the host device 512 may be a personal computer (PC), a laptop, a mobile phone, a tablet, a server, an embedded system, and a gaming console, but is not limited thereto. In at least one example embodiment, the host device 512 may be same as the host device defined in conjunction with FIG. 3, but the example embodiments are not limited thereto. In at least one example embodiment, the SRAM 504 may be same as the SRAM defined in conjunction with FIG. 4, but the example embodiments are not limited thereto.

The host device 512 may provide data to be written to the SB 302 to the processor 508. The processor 508 may divide the SB 302 into the plurality of sections based on a size of the SB and a size of SRAM, without impacting the WAF. In at least one example embodiment, the processor 508 may divide the plurality of pages 510 equally among the plurality of sections of the SB 302. In at least one example embodiment, the processor 508 may divide the plurality of pages 510 unequally among the plurality of sections of the SB 302, but the example embodiments are not limited thereto, and for example, the plurality of pages 510 may be equally divided among the plurality of sections of the SB 302. The processor 508 may determine a section among the plurality of sections of the SB 302 to write the data provided by the host device 512 and may write the data to the plurality of pages of the determined section. In at least one example embodiment, the host device 512 may be communicatively coupled with the flash memory 506 to directly write the data to the SB 302, but the example embodiments are not limited thereto.

For each section among the plurality of sections of the SB 302, the processor 508 may generate an SB L2P bitmap as the data is written to the section and/or in response to the writing of the data to the section, etc. The SB L2P bitmap may contain a plurality of L2P pages corresponding to the plurality of LPNs corresponding to the plurality of pages of the section. Each set bit of the SBL2P bitmap indicates that at least one LPN referred to by corresponding L2P page is present in the corresponding section of the SB. During data writing to the section and/or in response to the writing of the data to the section, the processor 508 may set the bit for an L2P pages corresponding to the LPN in the SB L2P bitmap corresponding to the page to which the data is written. The processor 508 may clear the bit for the L2P pages corresponding to the LPN in the SB L2P bitmap corresponding for the page to which the data is not written. If the data written on a page is changed or deleted, the processor 508 may clear the bit for the L2P pages corresponding to the LPN corresponding to that page in the SB L2P bitmap. Once the data writing operation is completed, the processor 508 may store the SB L2P bitmap in the flash memory 506, but is not limited thereto.

The processor 508 may perform the GC operation in a phased manner for the SSD 502. The processor may select an SB 302 among the plurality of SBs included in the flash memory 506 to start the GC operation. The processor 508 may generate the valid LPN bitmap for the selected SB 302 in the phased manner. The processor 508 may generate the plurality of parts of the valid LPN bitmap corresponding to the plurality of sections of the selected SB 302. Also, each bit of the Valid LPN Bitmap may represent the validity of a specific physical location of a map unit size.

The processor 508 may load an SB L2P bitmap corresponding to a section of the selected SB 302 into the SRAM 504. The processor 508 may analyze the SB L2P bitmap to determine one or more valid LPNs corresponding to one or more pages of the section that contains the data written by the host device during the generation of the SB L2P bitmap. Since each bit of the SBL2PBitmap represents a L2P page, for each bit set in SBL2PBitmap, the corresponding L2P Page is loaded from NAND memory to SRAM. The processor 508 may generate a part (e.g., subset, portion, etc.) of the valid LPN bitmap for the section. The part of the valid LPN bitmap may include the information corresponding to the one or more valid LPNs in the section of the selected SB 302. The processor 508 may execute the one or more GC read commands for the one or more L2P pages corresponding to the one or more valid LPNs included in the part of the valid LPN bitmap, and may perform the GC operation for the section of the selected SB 302. In at least one example embodiment, the processor 508 may store the generated part of the valid LPN bitmap in the flash memory to avoid re-generation of the valid LPN bitmap when the host device 512 wakes up from a sleeping state, but is not limited thereto. In this manner, the processor 508 may perform the GC operation for the SSD 502 in the phased manner by performing the GC operation for each section of the plurality of SBs included in the flash memory 506. Further, only one part among the plurality of parts of the valid LPN bitmap is generated at a time. In at least one example embodiment, the generated valid LPN Bitmaps are stored in a non-volatile memory during Normal Power Off (NPO) to avoid re-generation of the valid LPN Bitmap after waking up of the host device, but the example embodiments are not limited thereto.

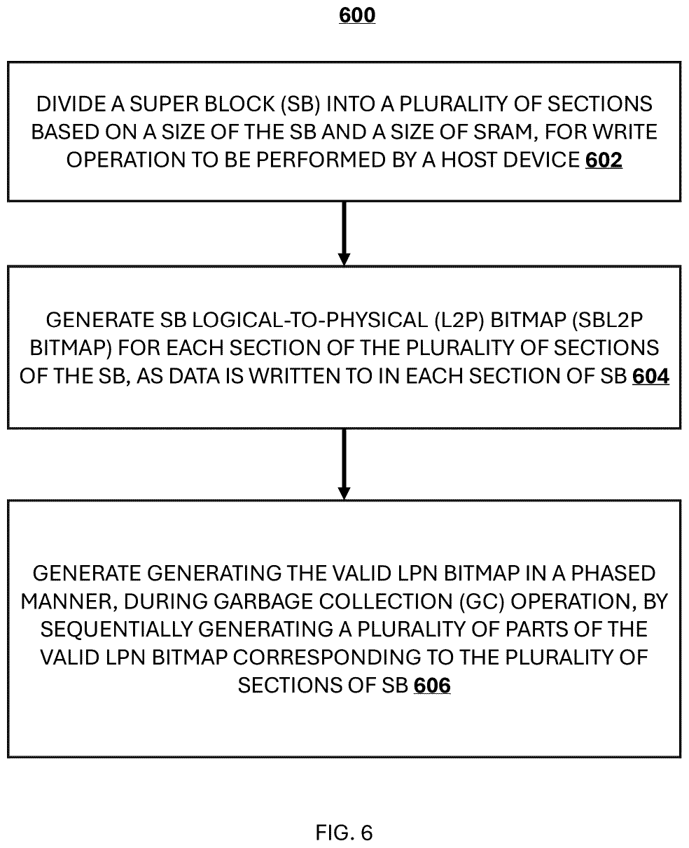

FIG. 6 illustrates a flow diagram of a method for generating valid LPN bitmap in accordance with at least one example embodiment of the inventive concepts. The blocks of the flow diagram shown in FIG. 6 have been arranged in a generally sequential manner for ease of explanation, however, it is to be understood that this arrangement is merely an example, and it should be recognized that the functionality/processing associated with method 600 (and the operations shown in FIG. 6) may occur in a different order (for example, where at least some of the functionality/processing associated with the blocks is performed in parallel and/or in an event-driven manner), some operations may be combined, some operations may be omitted, and/or additional operations may be included, etc.

At operation 602, the method comprises dividing a Super Block (SB) into a plurality of sections based on a size of the SB and a size of SRAM for write operation to be performed by a host device without impacting the Write Amplification Factor (WAF). The SB may be divided into the plurality of sections during a write operation being performed by a host device on the SB. The data may be written to the plurality of pages of the plurality of sections on the SB.

At operation 604, the method comprises generating an SB Logical-To-Physical (L2P) bitmap (e.g., a SBL2P bitmap) for each section of the plurality of sections of the SB as data is written into each section of the SB. The SB L2P bitmap may contain a plurality of L2P pages corresponding to the plurality of LPNs corresponding to the plurality of pages of the section for which the SB L2P bitmap is generated. As the data is written to the section of the SB, a bit may be set for an L2P page corresponding to the LPN in the SB L2P bitmap corresponding to L2P table indices of the LPNs written by the host device. The bit may be cleared for an L2P page corresponding to the LPN in the SB L2P bitmap, corresponding to the page to which the data is not written. If the data written on the page is changed and/or deleted, the bit for an L2P page corresponding to the LPN corresponding to that page may also be cleared in the SB L2P bitmap. Once the data writing operation is completed for the section, the SB L2P bitmap may be stored in the flash memory. Further, each bit of the SBL2P bitmap indicates that at least one LPN referred to by corresponding L2P page is present in the corresponding section of the SB.

At operation 606, the method further comprises generating the valid LPN bitmap in a phased manner during at least one Garbage Collection (GC) operation by sequentially generating a plurality of parts of the valid LPN bitmap corresponding to the plurality of sections of the SB, wherein each part of the valid LPN bitmap includes information of one or more valid LPNs for the corresponding section of the SB. For the generation of a part of the valid LPN bitmap corresponding to a section of the SB, an SB L2P bitmap corresponding to the section may be loaded into the SRAM of the SSD. In other words, a portion and/or subset of the SB L2P bitmap is loaded into the SRAM of the SSD, thereby reducing the memory requirements of the GC operation, etc. The SB L2P bitmap may be analyzed to determine one or more valid LPNs corresponding to one or more pages of the section that contain the data written by the host device during the generation of the SB L2P bitmap. Since each bit of SBL2PBitmap represents a L2P page, for each bit set in SBL2PBitmap, the corresponding L2P Page is loaded from NAND memory to the SRAM. The part of the valid LPN bitmap including the information about the one or more valid LPNs in the section may be generated. The one or more GC read commands may be executed for the one or more pages corresponding to the one or more valid LPNs included in the part of the valid LPN bitmap and the GC operation may be performed for the section of the SB 302. One or more parts of the valid LPN bitmap may be generated for the remaining sections of the SB in the same manner, and the GC operation may be performed for the SSD. Each bit of the Valid LPN Bitmap represents validity of a specific physical location of a map unit size.

As the GC operation is performed in the phased manner for the SB, only a part among the plurality of parts of the valid LPN bitmap may be desired and/or may need to be present in the SRAM at a single time. Thus, the GC operation may also be performed even if the size of the SRAM is less and/or reduced. Also, the problem of a host time-out may be solved as the SB L2P bitmap corresponding to only the section of the SB is loaded at a single time.

In this manner, one or more example embodiments of the inventive concepts may generate a valid LPN bitmap for a DRAMLess SSD in a phased manner.

While various aspects and example embodiments have been disclosed herein, other aspects and example embodiments will be apparent to those of ordinary skill in the art. The various aspects and example embodiments disclosed herein are for the purposes of illustration and are not intended to be limiting.

The order in which the various operations of the methods are described is not intended to be construed as a limitation, and any number of the described method operations can be combined in any order to implement the method. Additionally, individual operations may be deleted from the methods without departing from the spirit and scope of the inventive concepts described herein. Furthermore, the methods can be implemented in any suitable hardware and/or combination of hardware and software and/or hardware and firmware, etc.

The various operations of the methods described above may be performed by any suitable means capable of performing the corresponding functions. The means may include various hardware and/or software component(s) and/or module(s), including, but not limited to a circuit, an application specific integrated circuit (ASIC), or processor, etc. Generally, where there are operations illustrated in the Figures, those operations may be performed by any suitable corresponding counterpart means-plus-function components.

Furthermore, one or more non-transitory computer-readable storage media may be utilized in implementing example embodiments consistent with the inventive concepts. A non-transitory computer-readable storage medium refers to any type of physical memory on which information or data readable by a processor may be stored. Thus, a non-transitory computer-readable storage medium may store computer readable instructions for execution by one or more processors, including computer readable instructions for causing the processor(s) to perform operations consistent with the example embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Certain aspects of one or more example embodiments may comprise a non-transitory computer program product for performing one or more of the operations presented herein. For example, such a non-transitory computer program product may comprise a non-transitory computer readable media having computer readable instructions stored (and/or encoded) thereon, the instructions being executable by one or more processors to perform the operations described herein. For certain aspects, the non-transitory computer program product may include packaging material.

Various components, modules, and/or units are described herein to emphasize functional aspects of devices configured to perform the disclosed operations, but do not necessarily require realization by different hardware units. Rather, as described above, various units may be combined in a hardware unit and/or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise. The terms “including”, “comprising”, “having” and variations thereof, when used in a claim, is used in a non-exclusive sense that is not intended to exclude the presence of other elements or operations in a claimed structure or method, unless expressly specified otherwise.

Finally, the language used in the specification has been principally selected for readability and instructional purposes, and it may not have been selected to delineate and/or circumscribe the inventive subject matter. It is therefore intended that the scope of one or more example embodiments of the inventive concepts not be limited by this detailed description, but rather by any claims that issue on an application based here on. Accordingly, the example embodiments of the inventive concepts are intended to be illustrative, but not limiting, of the scope of the inventive concepts, which is set forth in the appended claims.

We claim:

1. A method of generating valid Logical Page Number (LPN) bitmaps for a storage device including a plurality of super blocks of non-volatile memory and a storage controller, the method comprising:
dividing a Super Block (SB) into a plurality of sections based on a size of the SB and a size of a volatile memory included in the storage controller, for a write operation to be performed by the storage device;
generating at least one SB Logical-to-Physical (L2P) bitmap (SBL2P bitmap) for at least one section of the plurality of sections of the SB, in response to a write request from a host device associated with the at least one section of the SB, each set bit of the SBL2P bitmap indicating that valid data is stored in at least one LPN in the at least one section of the SB; and
generating a valid LPN bitmap corresponding to the SB in response to a Garbage Collection (GC) operation based on the generated at least one SBL2P bitmap,
each bit of the valid LPN Bitmap representing validity information of data stored in a corresponding physical location of the SB.

2. The method of claim 1, wherein the generating the SBL2P bitmap for the at least one section of the SB further includes:
setting one or more bits in the SBL2P bitmap corresponding to L2P table indices of the LPNs written to the storage device by the host device.

3. The method of claim 2, further comprises:
storing the generated SB L2P bitmap in a non-volatile memory of the storage device.

4. The method of claim 1, wherein the generating the valid LPN bitmap corresponding to the SB further includes:
loading the SBL2P bitmap corresponding to the section of the SB for which the GC operation is to be performed;
determining one or more valid LPNs based on the loaded SBL2P bitmap, the determining including loading L2P pages corresponding to each set bit of the loaded SBL2P bitmap and parsing the loaded L2P pages;
generating a part of the valid LPN bitmap corresponding to the section of the SB based on the one or more valid LPNs; and
in response to completion of the GC operation using the generated part of the valid LPN bitmap, loading a SBL2P bitmap of a subsequent section of the SB to generate a subsequent part of the valid LPN bitmap.

5. The method of claim 1, wherein a single part of the valid LPN bitmap is generated at a time.

6. The method of claim 1, further comprising:
storing the generated valid LPN bitmap in a non-volatile memory of the storage device during a Normal Power Off (NPO) operation to avoid re-generation of the valid LPN bitmap after a wake up operation is performed by the host device.

7. An apparatus to generate valid Logical Page Number (LPN) bitmaps for a storage device, the apparatus comprising:
a storage controller including a volatile memory; and
a non-volatile memory including a plurality of Super Blocks (SBs), each SB including a plurality of physical blocks,
wherein the storage controller configured to,
divide a Super Block (SB) into a plurality of sections based on a size of the SB and a size of the volatile memory included in a storage controller, for a write operation to be performed by the storage device;
generate at least one SB Logical-to-Physical (L2P) bitmap (SBL2P bitmap) for at least one section of the plurality of sections of the SB, in response to a write request from a host device associated with the at least one section of the SB, each set bit of the SBL2P bitmap indicating that valid data is stored in at least one LPN in the at least one section of the SB; and
generate a valid LPN bitmap corresponding to the SB in response to a Garbage Collection (GC) operation based on the generated at least one SBL2P bitmap,
each bit of the valid LPN Bitmap representing validity information of data stored in a corresponding physical location of the SB.

8. The apparatus of claim 7, wherein the storage controller is further configured to generate the SBL2P bitmap for each section of the SB by:
setting one or more bits in the SBL2P bitmap corresponding to L2P table indices of the LPNs written to the storage device by the host device.

9. The apparatus of claim 8, wherein the storage controller is further configured to:
store the generated SB L2P bitmap in the non-volatile memory of the storage device.

10. The apparatus of claim 7, wherein the storage controller is configured to generate the valid LPN bitmap corresponding to the SB by:
Loading into the volatile memory the SBL2P bitmap corresponding to the section of the SB for which the GC operation is to be performed;
determining one or more valid LPNs based on the loaded SBL2P bitmap, the determining including loading L2P pages corresponding to each set bit of the loaded SBL2P bitmap and parsing the loaded L2P pages;
generating a part of the valid LPN bitmap corresponding to the section of the SB based on the one or more valid LPNs; and
in response to completion of the GC operation using the generated part of the valid LPN bitmap, loading into the volatile memory a SBL2P bitmap of a subsequent section of the SB to generate a subsequent part of the valid LPN bitmap.

11. The apparatus of claim 7, wherein a single part of the valid LPN bitmap is generated at a time.

12. The apparatus of claim 7, wherein the storage controller is further configured to:
store the generated valid LPN bitmap in the non-volatile memory of the storage device during a Normal Power Off (NPO) operation to avoid re-generation of the valid LPN bitmap after a wake up operation of the host device.

13. A system comprising:
at least one host device; and
a storage device including a non-volatile memory and a storage controller including a volatile memory, the storage controller configured to,
divide a Super Block (SB) of the non-volatile memory into a plurality of sections based on a size of the volatile memory;
generate a plurality of SB Logical-to-Physical (L2P) bitmaps (SBL2P bitmap), each SL2P bitmap corresponding to one section of the plurality of sections of the SB;
receive a write request from the at least one host device, the write request indicating a target section of the plurality of sections of the SB;
in response to the write request, set a bit of the SBL2P bitmap in a position of the SBL2P bitmap corresponding to the target section, the set bit indicating that valid data is stored in a Logical Page Number (LPN) corresponding to the target section; and
generate a valid LPN bitmap corresponding to the SB in response to an instruction to perform a Garbage Collection (GC) operation on the storage device based on the generated SBL2P bitmap, each bit of the valid LPN bitmap representing validity information of data stored in a corresponding physical location of the SB.

14. The system of claim 13, wherein the storage controller is further configured to:
store the generated SB L2P bitmap in the non-volatile memory.

15. The system of claim 13, wherein the storage controller is further configured to:
in response to receiving a request to change data stored in the target section of the plurality of sections of the SB, clearing the set bit of the SBL2P bitmap in the position of the SBL2P bitmap corresponding to the target section.

16. The system of claim 13, wherein the storage controller is further configured to:
in response to receiving a request to delete data stored in the target section of the plurality of sections of the SB, clearing the set bit of the SBL2P bitmap in the position of the SBL2P bitmap corresponding to the target section.

17. The system of claim 13, wherein the storage controller is further configured to:
receive a request to perform the GC operation on the SB from the at least one host device;
load a first SBL2P bitmap corresponding to a first section of the SB for which the GC operation is to be performed into the volatile memory from the non-volatile memory;
determine one or more valid LPNs based on the loaded first SBL2P bitmap, the determining including loading L2P pages corresponding to each set bit of the loaded first SBL2P bitmap into the volatile memory;
generate a first part of the valid LPN bitmap corresponding to the first section of the SB based on the one or more valid LPNs; and
in response to completion of the GC operation using the generated part of the valid LPN bitmap, load a second SBL2P bitmap corresponding to a second section of the SB to generate a second part of the valid LPN bitmap.

18. The system of claim 17, wherein the storage controller is further configured to:
load a single part of the valid LPN bitmap into the volatile memory at a time.

19. The system of claim 13, wherein the storage controller is further configured to:
store the generated valid LPN bitmap in the non-volatile memory during a Normal Power Off (NPO) operation of the host device.

20. The system of claim 19, wherein the storage controller is further configured to:
load the valid LPN bitmap into the volatile memory from the non-volatile memory after a wake up operation is performed by the host device.
